(19) United States
(12) Patent Application Publication
(10) Pub. No.: US 2020/0148472 A1
(43) Pub. Date: May 14, 2020

(54) SYSTEM FOR CONVEYING LOADS BETWEEN A PLURALITY OF STORAGE UNITS AND A PLURALITY OF PREPARATION STATIONS, THROUGH A HORIZONTAL LOAD-ROUTING NETWORK

(71) Applicant: SAVOYE, Dijon (FR)

(72) Inventors: Jean-Michel Collin, Merceuil (FR); Stephane Pietrowicz, Fixin (FR)

(21) Appl. No.: 16/628,184

(22) PCT Filed: Jul. 5, 2018
(86) PCT No.: PCT/EP2018/068213

§ 371 Date: Jan. 2, 2020

(30) Foreign Application Priority Data
Jul. 7, 2017 (FR) 1756449

(51) Int. Cl. B65G 1/04; B65G 1/137

(52) U.S. Cl. CPC B65G 1/0485; B65G 1/1378

(57) ABSTRACT

A system is proposed for conveying loads without sequencing, between storage units and preparation stations. The system includes first and second collecting conveyors, positioned on a same horizontal plane, parallel, mono-directional and having opposite directions of movement, to connect each storage unit to the first collector, storage unit entry and exit conveyors; to connect each preparation station to the second collector, preparation station entry and exit conveyors; for at least one couple including a storage unit and a preparation station facing each other on either side of the first and second collectors, a pair of junction conveyors interconnecting the first and second collecting conveyors and including outbound and return junction conveyors having opposite directions of movement.

### 1. CROSS-REFERENCE TO RELATED APPLICATIONS

This Application is a Section 371 National Stage Application of International Application No. PCT/EP2018/068213, filed Jul. 5, 2018, the content of which is incorporated herein by reference in its entirety, and published as WO 2019/008084 on Jan. 10, 2019, not in English.

### 2. TECHNICAL FIELD

The field of the invention is that of logistics.

More specifically, the invention relates to a system for conveying loads without sequencing, between a plurality of storage units and a plurality of preparation stations.

The storage units correspond for example to the different exits from alleys in an automated storage/removal warehouse.

The term “sequencing” (or “providing sequenced loads”), is understood to mean the providing, under a constraint of delivery, of at least one sequence comprising loads in a desired sequential order.

In the context of the present invention, it is assumed that in the outbound direction, the loads are conveyed from the storage units up to the preparation stations without being sequenced, and that the sequencing (if there is one) is done in each of the preparation stations. In other words, if a sequencing is needed, it is assumed that each preparation station is equipped for this purpose with a buffer storage and load sequencing system, for example, one of the types described in the patent applications FR1563151 dated 22 Dec. 2015 and FR1654863 dated 30 May 2016.

It is also assumed that the conveying system should be such that:
in the outbound direction, a load coming from any unspecified one of the storage units must be capable of being conveyed to any one whatsoever of the preparation stations or to any one whatsoever of the other storage units; and
in the return direction, a load coming from any unspecified one of the preparation stations must be capable of being conveyed to any unspecified one of the storage units or to any unspecified one of the other preparation stations.
   The present invention can be applied to any type of preparation station, and especially but not exclusively to:
stations for preparing customer orders (also called “picking stations”) where the preparing is done by the picking of items or goods from a storage containers (also called “load sources”): an operator (or a robot) receives a pick list (on paper, on a terminal screen, in voice form, or in the form of computer tasks (when it is a robot), etc.). For each package to be shipped (also called a “shipping container” or “target load”), this list informs the operator or robot about the quantity of each type of items or goods that he or it must collect in storage containers and group together in the package to be shipped; and
stations for the palletization of storage containers (also called “source loads”) themselves containing items: an operator (or a robot) receives a pick list (on paper, on a terminal screen, in voice form, in the form of computer tasks (when it is a robot), etc. For each pallet to be shipped (also called a “shipping container” or “target load”), this list informs the operator or robot about the quantity of storage containers of each type (for example cardboard boxes) that he must collect and unload onto the pallet to be shipped.

### 3. TECHNOLOGICAL BACKGROUND

Referring now to FIG. 1, a top view is presented of an example of a known configuration for an automated storage system for preparing customer orders comprising:
an automated storage/removal warehouse 7 comprising several sets (two in this example) each formed by an alley 7a, 7a′ feeding, on either side, a storage shelf 7b, 7c, 7b′, 7c′ with several superimposed stacking levels;
a set of conveyors taking the source loads from the automated warehouse 7 up to the preparation stations and vice versa. In the example of FIG. 1, we can distinguish:
   for the forward or outbound operation (i.e. from the automated warehouse 7 up to the preparation stations), conveyors referenced 9a and 9a′ (one per alley) as well as 6 and 8; and
   for the return operation (i.e. from the preparation stations up to the automated warehouse 7), conveyors referenced 8′, 6′ as well as 9b and 9b′ (one per alley); in this example, the conveyor 6′ and 8′ are superimposed on the conveyors 6 and 8;
several customer-order preparation stations 10a to 10f, each occupied by an operator 1a to 1f and extending perpendicularly to the conveyors referenced 8 and 8′; and
a management system (also called a management unit) that is a computer-based central management system responsible for managing the entire system (the automated storage/removal warehouse 7, the set of conveyors 6, 6′, 8, 8′, 9a, 9a′, 9b and 9b′ and the preparation stations 10a to 10f).

The management system also manages the list of customer orders associated with each shipping container (target load) and therefore the sequential order of the customer order lines forming this list, as a function of the location of the storage containers (source loads) in the automated warehouse 7, the availability of the trolleys and the elevators of the automated warehouse 7 as well as requirements in terms of items and goods of the different shipping containers to be prepared that succeed one and other at the preparation station. The purpose of this is to optimize all the movements and the preparation times for the shipping containers and ensure synchronization between the arrival, at the preparation station, of a shipping container and the corresponding storage containers (containing goods indicated in the customer order list associated with this storage container).

In the example of FIG. 1, each preparation station comprises two conveyor circuits: a first conveyor circuit for the storage containers, formed by two horizontal columns of conveyors; one column (the forward or outbound column 2) for moving the storage containers from the third sub-set of conveyors 8 up to the operator 1a and the other column (the return column 3) for the reverse movement; and a second circuit of conveyors for the shipping containers, formed by two horizontal columns of conveyors: one (forward or outbound column 4) for moving the shipping containers from the third sub-set of conveyors 8 up to the operator 1a and the other (return column 5) for the reverse movement.

A buffer storage function (also called an “accumulation function”) for buffering a determined quantity of containers upstream to the operator (or automaton) is set up in each of the first and second circuits, by the outbound column 3 and 4 (composed of classic horizontal conveyors). A storage container therefore makes the following journey: it is picked up by a trolley in the automated warehouse 7, and is then conveyed successively by one of the conveyors 9a and 9a′ (depending on whether it arrives at the alley 7a or 7a′) and by the conveyors 6 and 8 and finally by the conveyors of the forward or outbound column 2 to be presented to the operator. In the other direction (after presentation to the operator), the storage container makes the reverse journey: it is conveyed by the conveyors of the return column 3, then by the conveyors 8′ and 6′ and finally by one of the conveyors 9b and 9b′ (depending on whether it is returning to the alley 7a or the alley 7a′) and is then re-positioned in the automated warehouse 7 by means of a trolley.

As mentioned further above, the containers (source loads and target loads) has to be presented to the operator in a desired sequential order forming at least one determined sequence. Classically, this sequential order of arrival is pre-determined by the management system (i.e. it is determined, for each container, before this container reaches the preparation station) and, if necessary, recomputed during the conveying of the containers from the automated warehouse 7 exit to the preparation station (for example to cope with a malfunction of an element of the system).

In a first known implementation of the sequencing (i.e. the sequencing function), a first level of sequencing is obtained by the deposition of the pre-sequenced loads on each of the conveyors 9a and 9a′. There are therefore constraints on the automated warehouse 7. In other words, the loads deposited on the conveyor 9a are in a sequential order consistent with that of the final desired sequential order and the loads deposited on the conveyor 9a′ are also in a sequential order consistent with that of the final desired sequential order. Then, a second level of sequencing is achieved through the deposition on the conveyor 6, in the final desired sequential order, of the loads coming from the conveyors 9a and 9a′. For example, for a sequence of seven loads, if the loads of ranks 1, 2, 4 and 5 are stored in the alley 7a, they are deposited in this order on the conveyor 9a and if the loads of the ranks 3 and 6 are stored in the alley 7a′, they are deposited in this order on the conveyor 9a′; then, the seven loads are deposited on the conveyor 6 in ascending order (from 1 to 7) of their ranks.

In a second known implementation of the sequencing operation, in order to relax the constraints on the automated warehouse 7, it is accepted that the containers will not exit the automated warehouse 7 in the desired sequential order (i.e. the order in which they has to be presented to the operator). It is therefore necessary to carry out two operations, one for conveying and the other for sequencing the containers between the automated warehouse 7 and the preparation station where the operator is situated. The elimination of the sequencing constraints, which usually weigh on the automated warehouse 7, significantly increases the performance of this automated warehouse (and more generally of the different upstream devices) and therefore reduces its size and complexity and therefore its cost. In the example of FIG. 1, these conveying and sequencing functions are performed as follows for a given preparation station: the storage containers circulate in a loop (also called a carousel) formed by the conveyors 6, 8, 8′ and 6′ and when the next storage container of the sequence awaited by the given preparation station comes before before the outbound column 3 of this given preparation station, this storage container is transferred to the conveyors of the outbound column 3. A storage container must make a turn of the loop if it comes before the outbound column 3 of the given preparation station while at least one of storage containers that precede it in the sequence has not yet been transferred to the outbound column 3 of the given preparation station. This method is performed for each of the storage containers awaited in the sequence (i.e. in the desired sequential order of arrival at the preparation station)

It will be noted that in a known way, the above-mentioned principle of the loop (carousel) is also used to carry out the single function of conveying loads (in FIG. 1, between on the one hand the entry conveyors 9b, 9b′/exit conveyors 9a, 9a′ of the alleys 7a, 7a′ of the automated store 7 and on the other hand the entry conveyors 3, 4/exit conveyors 2, 5 of the preparation stations 10a to 10f). In other words, if there is no sequencing or if the sequencing is done in each of the preparation stations, the carousel or loop is used solely for conveying the loads. In this case, and returning to the example of FIG. 1, the storage containers circulate on the loop or carousel formed by the conveyors 6, 8, 8′ and 6′ and, as soon as the storage container intended for the given preparation station comes before the outbound column 3 of this preparation station, it is transferred to this outbound column 3.

The use of a loop (carousel) to carry out the load-conveying function but not the sequencing function is not an optimum solution in terms of distance travelled by the loads or even less in terms of quantity of loads that can be conveyed simultaneously.

Thus, in the example of FIG. 1, to carry out a round trip between one of the alleys 7a, 7a′ of the automated warehouse 7 and one of the preparation stations 10a to 10f, a load must travel through the entire loop.

In addition, certain sections of the loop are travelled by all the loads: on the outbound journey, the section situated between the connection point (on the conveyor 6 of the loop) of the exit conveyor 9a of the alley 7a and the connection point (on the conveyor 8 of the loop) of the entry conveyor 3 or 4 of the preparation station 10a; on the return journey, the section situated between the connection point (on the conveyor 8′ of the loop) of the exit conveyor 2 or 5 of the preparation station 10a and the connection point (on the conveyor 6′ of the loop) of the entry conveyor 9b of the alley 7a.

In the least favorable case, i.e. to travel the longest path (outbound or return) between one of the alleys 7a, 7a′ of the automated warehouse 7 and one of the preparation stations 10a to 10f, a load must pass before the other alley or alleys of the automated warehouse 7 and the other preparation station or stations. In the example of FIG. 1, to travel the longest outbound path between the alley 7a40 and the preparation station 10f, a load must pass before the other alley 7a and the other preparation stations 10a to 10e. Similarly, to travel through the longest return path between the preparation station 10f and the alley 7a, a load must pass before the other preparation stations 10a to 10e and before the other alley 7a.

### 4. SUMMARY OF THE INVENTION

One particular embodiment of the invention proposes a system for conveying loads without sequencing, between a plurality of storage units and a plurality of preparation stations. This system comprises:
first and second collecting conveyors, positioned on a same horizontal plane, parallel, mono-directional and having opposite directions of movement;
to connect each storage unit to the first collecting conveyor, a storage unit entry conveyor and a storage unit exit conveyor;
to connect each preparation station to the second collecting conveyor, a preparation station entry conveyor and a preparation station exit conveyor;
for at least one couple comprising a storage unit and a preparation station facing each other on either side of the first and second collecting conveyors, a pair of junction conveyors interconnecting the first and second collecting conveyors and comprising:
   an outbound junction conveyor having a direction or sense of movement from the first to the second collecting conveyor; and
   a return junction conveyor having a direction of movement from the second to the first collecting conveyor.

The general principle of the invention consists therefore of the setting up, between the storage units and the preparation stations, of a horizontal load-routing network having a structure comprising the following elements: the first and second collecting conveyors, the storage unit entrance conveyors, the storage unit exit conveyors, the preparation station entrance conveyors, the preparation station exit conveyors, the outbound junction conveyor and the return junction conveyor. The outbound junction conveyor and the return junction conveyor provide direct junctions between the first and second collecting conveyors.

This horizontal load routing network is simple to implement because all its elements are positioned in the same horizontal plane.

In addition, it does away with the use of an endless loop (carousel) to carry out the load-conveying function. This minimizes the distance travelled by each load and increases the quantity of loads that can be conveyed (distributed) simultaneously.

According to one particular characteristic, the outbound junction conveyor is aligned with the storage unit exit conveyor and the preparation station entry conveyor, respectively associated with the storage unit and with the preparation station of said at least one couple. In addition, the return junction conveyor is aligned with the storage unit entry conveyor and the preparation station exit conveyor respectively associated with the storage unit and the preparation station for said at least one couple.

Thus, the distance travelled by each load is even further reduced.

According to one particular characteristic, the storage unit entrance conveyors, the storage unit exit conveyors, the preparation station entrance conveyors, the preparation station exit conveyors, the outbound junction conveyors and the return junction conveyors are perpendicular to the first and second collecting conveyors.

Thus, the horizontal routing network is constituted by two mutually parallel collecting conveyors and by conveyors perpendicular to these two collecting conveyors. This simple and efficient horizontal routing structure facilitates the conveying (“routing”) of the loads between the storage units and the preparation stations.

According to one particular characteristic, for a conveying of loads between N storage units and M preparation stations, K couples each comprising a storage unit and a preparation station facing each other on either side of the first and second collecting conveyors, with K=min (N, M), the system comprises a pair of junction conveyors for each of the K couples.

In this way, by maximizing the number of couples each comprising a storage unit and a preparation station facing each other, the invention optimizes (minimizes) the number of pairs of junction conveyors needed, within the horizontal routing network, for the conveying of loads from/to the storage units and the preparation stations of these pairs.

One particular characteristic of the invention relates to the case where a given load has to be conveyed from a given storage unit, of which the associated storage unit exit conveyor is connected to the first collecting conveyor at a first connection point, to a given preparation station, of which the associated preparation station entry conveyor is connected to the second collecting conveyor at a second connection point. In this case, the system comprises a unit for managing collecting conveyors and junction conveyors of said system, said management unit being configured so that, between the first and second connection points, the given load is transported in travelling through a minimum distance:
via an outbound junction conveyor positioned between the given storage unit and the given preparation station, if the given storage unit and the given preparation station face each other;
via a portion of the first collecting conveyor and an outbound junction conveyor positioned facing the given preparation station, if the given storage unit is upstream to the given preparation station, in the direction of movement of the first collecting conveyor;
via an outbound junction conveyor positioned facing the given storage unit and a portion of the second collecting conveyor, if the given storage unit is downstream to the given preparation station, in the direction of movement of the first collecting conveyor.

Thus, in the case of a conveying of a load from a storage unit to a preparation station, the structure of the horizontal routing network ensures that the load travels a minimum distance.

One particular characteristic of the invention is related to the case where a given load has to be conveyed from a first given storage unit, of which the associated storage unit exit conveyor is connected to the first collecting conveyor at a first connection point, to a second given storage unit, of which the associated storage unit entry conveyor s connected to the first collecting conveyor at a third connection point. In this case, the system comprises a management unit for managing the collecting conveyors and the junction conveyors of said system, said management unit being configured so that between the first and third connection points, the given load is transported in travelling through a minimum distance:
via a portion of the first collecting conveyor, if the first given storage unit is upstream to the second given storage unit, in the direction of movement of the first collecting conveyor;
via an outbound junction conveyor positioned facing the first given storage unit, a portion of the second collecting conveyor and a portion of the return junction conveyor positioned facing the second given storage unit, if the first given storage unit is downstream to the second given storage unit, in the direction of movement of the first collecting conveyor.

Thus, in the case of a conveying of a load from a first storage unit to a second storage unit, the horizontal network routing structure ensures that the load travels through a minimum distance.

According to one particular characteristic, the invention is situated in the case where a given load has to be conveyed from a given preparation station, of which the associated preparation station exit conveyor is connected to the second collecting conveyor at a fourth connection point, to a given storage unit, of which the associated storage unit entry conveyor is connected to the first collecting conveyor at a fifth connection point. In this case, the system comprises a management unit for managing the collecting conveyors and the junction conveyors of said system, said management unit being configured so that, between the fourth and fifth connection points, the given load is transported in travelling a minimum distance:
via a return junction conveyor positioned between the given preparation station and the given storage unit, if the given storage unit and the given preparation station face each other;
via a portion of the second collecting conveyor and a return junction conveyor positioned facing the given storage unit, if the given storage station is upstream to the given preparation station, in the direction of movement of the first collecting conveyor;
via a return junction conveyor positioned facing the given preparation station, a portion of the first collecting conveyor if the given storage unit is downstream is downstream to the given preparation station, in the direction of movement of the first collecting conveyor.

Thus, in the case of a conveying of a load from a preparation station to a storage unit, the horizontal routing network structure ensures that the load will travel a minimum distance.

One particular characteristic of the invention relates to the case where a given load has to be conveyed from a first given preparation station, of which the associated preparation station exit conveyor is connected to the second collecting conveyor at a fourth connection point, to a second given preparation station, of which the associated given preparation station entry conveyor is connected to the second collecting conveyor at a sixth connection point. In this case, the system comprises a management unit for managing the collecting conveyors and junction conveyors of said system, said management unit being configured so that, between the fourth and sixth connection points, the given load is transported in travelling a minimum distance:
via a portion of the second collecting conveyor, if the first given preparation station is downstream to the given second preparation station, in the direction of movement of the first collecting conveyor;
via a return junction conveyor positioned facing the first given preparation station, a portion of the first collecting conveyor and an outbound junction conveyor positioned facing the second given preparation station, if the first given preparation station is upstream to the second given preparation station, in the direction of movement of the first collecting conveyor.

Thus, in the case of a conveying of a load from a first preparation station to a second preparation station, the structure of the horizontal routing network ensures that the load will travel a minimum distance.

According to one particular characteristic, for at least one storage unit that does not face a preparation station and is situated in the direction of movement of the first collecting conveyor, upstream to the first other storage unit facing a preparation station, the system comprises a single junction conveyor which is a return junction conveyor interconnecting the first and second collecting conveyors in the direction going from the first to the second collecting conveyor, and is preferably aligned with the entry conveyor of the storage unit associated with said at least one storage unit.

Thus, for such a storage unit (not coupled with a preparation station and upstream—in the direction of forward feed of the loads on the first collecting conveyor—to the first other storage unit facing a preparation station), a return junction conveyor is sufficient (there is no need for an outbound junction conveyor).

According to one particular characteristic, for at least one storage unit that is not facing a preparation station and is situated along the direction of movement of the first collecting conveyor, downstream to the last other storage unit facing a preparation station, the system comprises a single junction conveyor which is an outbound junction conveyor interconnecting the first and second collecting conveyors in the direction going from the first collecting conveyor to the second collecting conveyor and which is preferably aligned with the storage unit exit conveyor associated with said at least one storage unit.

Thus, for such a storage unit (not coupled with a preparation station and downstream (in the direction of forward feed of the loads on the first collecting conveyor) to the last other storage unit facing a preparation station), an outbound junction conveyor is sufficient (there is no need for a return junction conveyor).

According to one particular characteristic, for at least one storage unit that is not facing a preparation station and is situated along the direction of movement of the first collecting conveyor, between two other storage units each facing a preparation station, the system comprises a pair of junction conveyors interconnecting the first and second collecting conveyors in opposite directions of movement and comprising an outbound junction conveyor having a direction of movement from the first to the second collecting conveyor and preferably aligned with the storage unit exit conveyor associated with said at least one storage unit, and a return junction conveyor, having a direction of movement from the second to the first collecting conveyor, and preferably aligned with the entry conveyor of the storage unit associated with said at least one storage unit.

Thus, for such a storage unit (not coupled with a preparation station and situated between two other storage units each facing a preparation station), a return junction conveyor and an outbound junction conveyor are needed.

According to one particular characteristic, for at least one preparation station that does not face a storage unit and is situated, in the direction of movement of the second collecting conveyor, upstream to the first other preparation station, facing a storage unit, the system comprises a single junction conveyor which is an outbound junction conveyor interconnecting the first and second collecting conveyors in the direction going from the first to the second collecting conveyor, and which is preferably aligned with the preparation station entry conveyor associated with said at least one preparation station.

Thus, for a preparation station of this kind (not coupled with a storage unit and upstream—in the direction of forward feed of the loads on the second collecting conveyor—to the first other preparation station facing a storage unit), an outbound junction conveyor suffices (there is no need for a return junction conveyor).

According to one particular characteristic, for at least one preparation station that does not face a storage unit and is situated in the direction of movement of the second collecting conveyor, downstream to the last other preparation station facing a storage unit, the system comprises a single junction conveyor that is a return junction conveyor interconnecting the first and second collecting conveyors in the direction going from the second to the first collecting conveyor, and which is preferably aligned with the associated preparation station exit conveyor associated with said at least one preparation station.

Thus, for such a preparation station (not coupled to a storage unit downstream—in the direction of forward feed of the loads on the second collecting conveyor—to the last other preparation station facing a storage unit), a return junction conveyor suffices (there is no need for an outbound junction conveyor).

According to one particular characteristic, for at least one preparation station that does not face a storage unit and is situated, in the direction of movement of the second collecting conveyor, between two other preparation stations each facing a storage unit, the system comprises a pair of junction conveyors interconnecting the first and second collecting conveyors in opposite directions of movement and comprising an outbound junction conveyor, having a direction of movement from the first to the second collecting conveyor and being preferably aligned with the entry conveyor of the preparation station, associated with said at least one preparation station, and a return junction conveyor, having a direction of movement from the second to the first collecting conveyor and being preferably aligned with the preparation station exit conveyor associated with at least one preparation station.

Thus, for such a preparation station (not coupled to a storage unit and situated between two other preparation stations each facing a storage unit), a return junction conveyor and an outbound junction conveyor are necessary.

### 5. LIST OF FIGURES

Other features and advantages of the invention shall appear from the following description, given by way of a non-exhaustive and indicatory example and from the appended drawings of which:

FIG. 1, already described with reference to the prior art, is a top view of an automated sequential order preparing system;

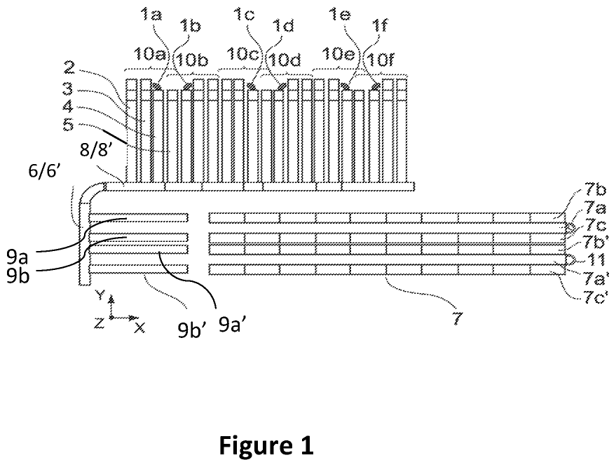

FIG. 2 illustrates a system for conveying loads according to a first embodiment of the invention (with four storage units and four preparation stations);

FIG. 3 illustrates a system for conveying loads according to a second embodiment of the invention (with five storage units and four preparation stations);

FIG. 4 illustrates a system for conveying loads according to a third embodiment of the invention (with seven storage units and four preparation stations);

FIG. 5 illustrates a system for conveying loads according to a fourth embodiment of the invention (with four storage units and five preparation stations);

FIG. 6 illustrates a system for conveying loads according to a fifth embodiment of the invention (with four storage units and seven preparation stations);

FIG. 7 illustrates a first example, in the context of the system of FIG. 2, of outbound and return pathways for a load;

FIG. 8 illustrates a second example, in the context of the system of FIG. 2, of outbound and return pathways for a load;

FIG. 9 illustrates a third example, in the context of the system of FIG. 2, of outbound and return pathways for a load; and

FIG. 10 is an example of a structure of a managing unit according to one particular embodiment of the invention.

### 6. DETAILED DESCRIPTION

In all the figures of the present document, identical elements and steps are designated by a same numerical reference.

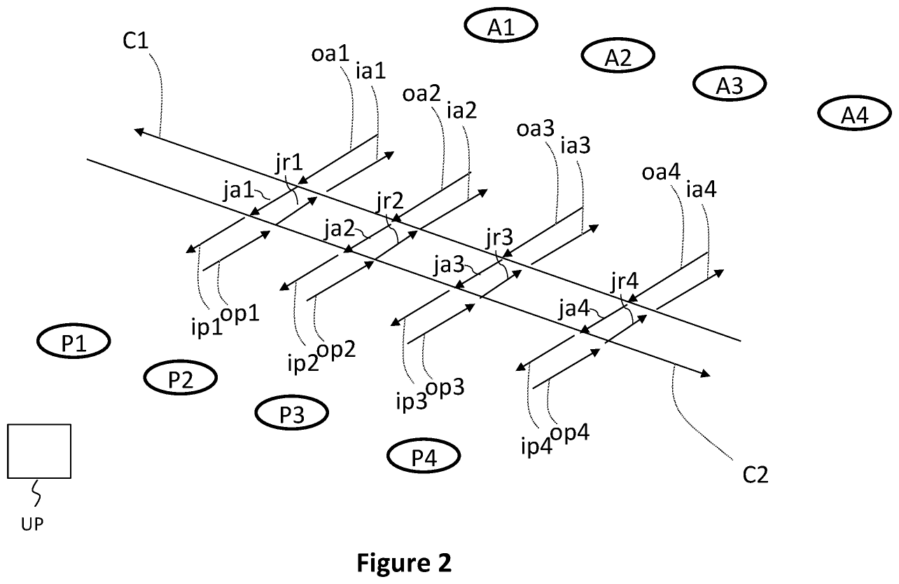

FIG. 2 illustrates a load-conveying system according to a first embodiment of the invention. It is configured to convey loads, without sequencing, between N storage units A1 to A4 (which correspond for example to the different alley exits of an automated storage/removal warehouse) and M preparation stations P1 to P4, with N=M=4. In variants of this first embodiment, we also have N=M, but with a value of N different from four.

As already mentioned further above, if a sequencing is necessary, it is assumed that each preparation station is equipped to this effect with a buffer storage and load sequencing system (for example one of the types described in the patent applications FR1563151 dated 22 Dec. 2015 and FR1654863 dated 30 May 2016).

The system comprises two collectors (i.e. collecting conveyors), a plurality of conveyors and a managing unit. All these elements are described in detail here below.

In general, the direction of movement of each collector or conveyor (i.e. the direction of movement of the loads on this conveyor) is illustrated in the figures by the direction of the arrow schematically representing this collector or conveyor.

One of the collectors, called a “first collector” is referenced C1. The other, called “second collector”, is referenced C2. They are positioned on a same plane. They are rectilinear and parallel. They have opposite directions of movement. In FIG. 2, the direction of movement of the first collector C1 is from right to left and that of the second collector C2 is from left to right. They are called “direction SC1” and “direction SC2” here below in the description.

Each storage unit A1 to A4 is connected to the first collector C1 by a pair of conveyors comprising a storage unit entry conveyor ia1 to ia4 and a storage unit exit conveyor oa1 to oa4.

Each preparation station P1 to P4 is connected to the second collector C2 by a pair of conveyors comprising a preparation station entry conveyor ip1 to ip4 and a preparation station exit conveyor op1 to op4.

The four storage units A1 to A4 and the four preparation stations P1 to P4 form four pairs (A1, P1), (A2, P2), (A3, P3), (A4, P4) each comprising a storage unit and a preparation station facing each other on either side of the first and second collectors C1, C2. For each of these pairs, the system comprises a pair of a junction conveyors interconnecting the first and second collectors C1, C2 and comprising:
an outbound junction conveyor ja1 to ja4, having a direction of movement from the first to the second collector and aligned with the exit conveyor of the storage unit oa1 to oa4 and the preparation station entry conveyor ip1 to ip4 respectively associated with the storage unit A1 to A4 and with the preparation station P1 to P4 of the concerned couple; and
a return junction conveyor jr1 to jr4, having a direction of movement from the second to the first collector, and aligned with the storage unit entry conveyor ia1 to ia4 and the preparation station exit conveyor opt to op4 respectively associated with the storage unit A1 to A4 and with the preparation station P1 to P4 of the concerned couple.

For example, for the couple (A1, P1), the system comprises the following pair of junction conveyors:
the outbound junction conveyor ja1 aligned with the storage unit exit conveyor oa1 and the preparation station entry conveyor ip1; and
the return junction conveyor jr1 aligned with the storage unit entry conveyor ia1 and the preparation station exit conveyor op1.

In one variant, for a couple comprising a storage unit and a preparation station facing each other on either side of the first and second collectors, the outbound junction conveyor ja1 to ja4 is not aligned with the storage unit exit conveyor oa1 to oa4 nor is it aligned with the preparation station entry conveyor ip1 to ip4, and the return junction conveyor jr1 to jr4 is not aligned with the storage unit entrance conveyors ia1 to ia4, nor is it aligned with the preparation station exit conveyors op1 to op4.

In the particular embodiment of FIG. 2, the storage unit entrance conveyors ia1 to ia4, the storage unit exit conveyors oa1 to oa4, the preparation station entrance conveyors ip1 to ip4, the preparation station exit conveyors op1 to op4, the outbound junction conveyors ja1 to ja4 and the return junction conveyors jr1 to jr4 are perpendicular to the first and second collectors C1, C2.

The managing unit UP manages the collectors and conveyors described here above, to enable different types of load transfer that are described in detail here below:
from a storage unit to a preparation station;
between two storage units;
from a preparation station to a storage unit;
between two preparation stations.

Transfer of a Load from a Storage Unit to a Preparation Station

Let us consider the case of a load that has to be conveyed:
from a storage unit Ai (with Ai ∈ {A1, A2, A3, A4}), of which the associated storage unit exit conveyor oai (with oai ∈ {oa1, oa2, oa3, oa4}) is connected with the first collector C1 at a first connection point (denoted oai/C1, because it is at the intersection between oai and C1),
to a preparation station Pj (with Pj ∈ {P1, P2, P3, P4}), of which the associated preparation station entry conveyor ipj (with ipj ∈ {ip1, ip2, ip3, ip4}) is connected to the second collector C2 at a second connection point (denoted C2/ipj, because it is at the intersection between C2 and ipj).

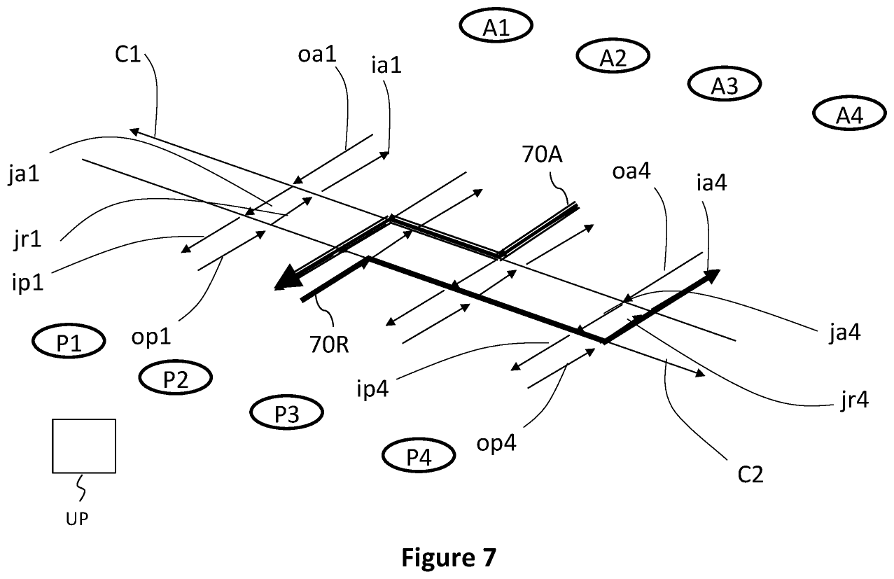

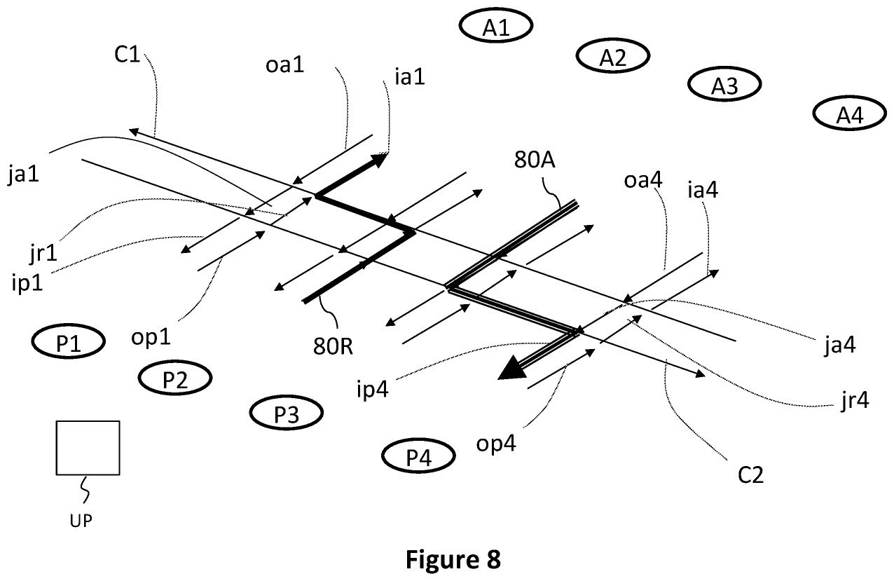

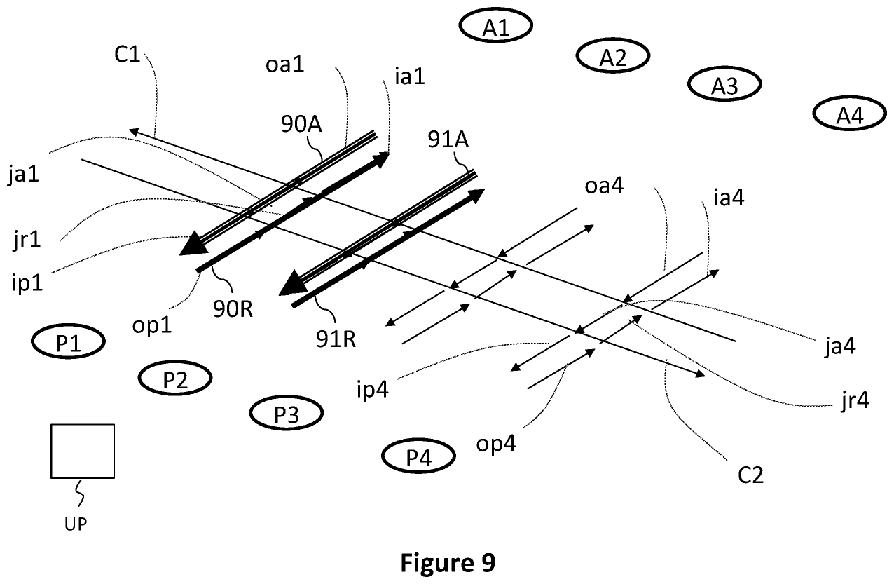

In this case, the managing unit UP is configured to manage the first and second collectors C1, C2, the outbound junction connectors ja1 to ja4 and the return junction connectors jr1 to jr4 so that between the first and second connection points (oai/C1 and C2/ipi), the loads are transported in travelling a minimum distance. It is possible to distinguish between the following three situations:
case 1: if the storage unit Ai and the preparation station Pj face each on either side of the first and second collectors C1, C2, the shortest path between the first and second connection points (oai/C1 and C2/ipi) is formed by the outbound junction conveyor jai (the one facing the storage unit Ai and the preparation station Pj). This is the case of each of the two outbound paths 90A and 91A represented in bold double line in FIG. 9;
case 1: if the storage unit Ai is situated upstream to the preparation station Pj in the direction SC1, the shortest path between the first and second connection points (oai/C1 and C2/ipi) is formed by a portion of the first collector C1 followed by the outbound junction conveyor jaj (the one facing the preparation station Pj). This is the case with the outbound path 70A represented by a bold double line in FIG. 7;
case 3: if the storage unit Ai is situated downstream to the preparation station Pj along the direction SC1, the shortest path between the first and second connection points (oai/C1 and C2/ipi) is formed by the outbound junction conveyor jai (the one facing the storage unit Ai) followed by a portion of the second collector C2. This is the case with the outbound path 80A represented by a bold double line in FIG. 8.

Transfer of a Load between Two Storage Units

Let us consider the case of a load that has to be conveyed:
from a first storage unit Ai (with Ai ∈ {A1, A2, A3, A4}), of which the associated storage unit exit conveyor oai (with oai ∈ {oa1, oa2, oa3, oa4}) is connected to the first collector C1 at a first connection point (denoted oai/C1, because it is at the intersection between oai and C1),
to a second storage unit Aj different from the first storage unit (with Aj ∈ {A1, A2, A3, A4}), of which the associated storage unit entry conveyor iaj (with iaj ∈ {ia1, ia2, ia3, ia4}) is connected to the first collector C1 at a third connection point (denoted C1/iaj, because it is at the intersection between C2 and iaj).

In this case, the managing unit UP is configured to manage the first and second collectors C1, C2, the outbound junction conveyors ja1 to ja4 and the return junction conveyors jr1 to jr4, so that between the first and third connection points (oai/C1 and C1/iaj), the load is transported in travelling a minimum distance. The following two situations can be distinguished:
case 1: if the first storage unit Ai is situated upstream to said second storage unit Aj along the direction SC1, the shortest path between the first and third connection points (oai/C1 and C1/iaj) is formed by a portion of the first collector C1;
case 2: if the first storage unit Ai is situated downstream from the second storage unit Aj along the direction SC1, the shortest path between the first and third connection points (oai/C1 and C1/iaj) is formed by the outbound junction conveyor jai (the one facing the first storage unit Ai) followed by a portion of the second collector C2 and a return junction conveyor jrj (the one facing the second storage unit Aj).

Transfer of a Load from a Preparation Station to a Storage Unit

Let us consider the case of a load that has to be conveyed:
from a preparation station Pi′ (with Pi′ ∈ {P1, P2, P3, P4}), of which the associated preparation station exit conveyor opi′ (with opi′ ∈ {op1, op2, op3, op4}) is connected to the second collector C2 at the fourth connection point (denoted opi′/C2, because it is at the intersection between opi′ and C2),
to a storage unit Aj′ (with Aj′ ∈ {A1, A2, A3, A4}), of which the storage unit entry conveyor iaj′ (with iaj′ ∈ {ia1, ia2, ia3, ia4}) is connected to the first collector C1 at a fifth connection point (denoted C1/iaj′, because it is at the intersection between C1 and iaj′).

In this case, the driving unit UP is configured to drive the first and second collectors C1, C2, the outbound junction conveyors ja1 to ja4 and the return junction conveyors jr1 to jr4, so that between the fourth and fifth connection points (opi′/C2 and C1/iaj′), the load is transported in travelling a minimum distance. The following three situations can be distinguished:
case 1: if the storage unit Ai′ and the preparation station Pj′ are facing each other on either side of the first and second collectors C1, C2, the shortest path between the fourth and fifth connection points (opi′/C2 and C1/iaj′) is formed by the return junction conveyor jri′ (the one facing the storage unit Ai′ and the preparation station Pj′). This is the case for each of the two return paths 90R and 91R represented in a single bold line in FIG. 9;
case 2: if the storage unit Ai′ is situated upstream to the preparation station Pj′ along the direction SC1, the shortest path between the fourth and fifth connection points (opi′/C2 and C1/iaj′) is formed by a portion of the second collector C2 followed by the return junction conveyor jri′ (the one facing the storage unit Ai′). This is the case with the return path 70R represented in a single bold line in FIG. 2;
case 3: if the storage unit Ai′ is situated downstream to the preparation station Pj′ along the direction SC1, the shortest path between the fourth and fifth connection points (opi′/C2 and C1/iaj′) is formed by the return junction conveyor jrj′ (the one facing the preparation station Pj′) followed by a portion of the first collector C1. This is the case with the return path 80R represented in a single bold line in FIG. 8.

Transfer of a Load between Two Preparation Stations

Let us consider the case of a load to be conveyed:
from a first preparation station Pi (with Pi ∈ {P1, P2, P3, P4}), of which the associated preparation station exit conveyor opi (with opi ∈ {op1, op2, op3, op4}) is connected to the second collector C2 at a fourth connection point (denoted opi/C2, because it is at the intersection between opi and C2),
to a second preparation station Pj different from the first (with Pj ∈ {P1, P2, P3, P4}), of which the associated preparation station entry conveyor ipj (with ipj ∈ {ip1, ip2, ip3, ip4}) is connected to the second collector C2 at a sixth connection point (denoted C2/ipj, because it is at the intersection between C2 and ipj).

In this case, the managing unit UP is configured to manage the first and second collectors C1, C2, the outbound junction conveyors ja1 to ja4 and the return junction conveyors jr1 to jr4, so that between the fourth and fifth connection points (opi/C2 and C2/ipj), the load is transported in travelling a minimum distance. The following two situations can be distinguished:
case 1: the first preparation station Pi is situated downstream from the second preparation station Pj along the direction SC1, the shortest path between the fourth and fifth connection points (opi/C2 and C2/ipj) is formed by a portion of the second collector C2;
case 2: if the first preparation station Pi is situated upstream to the second preparation station Pj along the direction SC1, the shortest path between the fourth and fifth connection points (opi/C2 and C2/ipj) is formed by the return junction conveyor jri (the one facing the first preparation station Pi) followed by a portion of the first collector C1 and an outbound junction conveyor jaj (the one facing the second preparation station Pj).

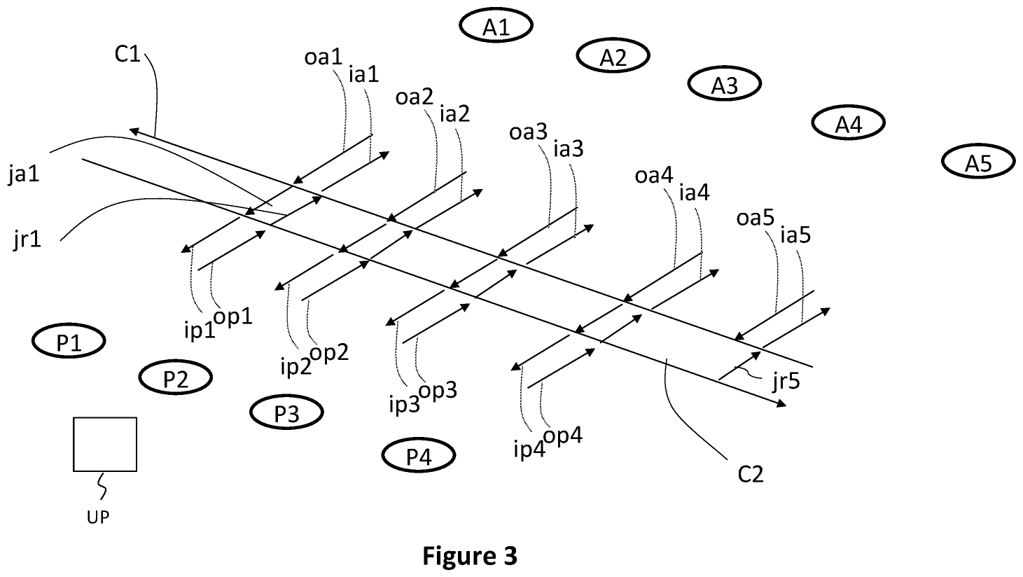

FIG. 3 illustrates a system for conveying loads according to a second embodiment of the invention, which is distinguished from the first embodiment (the one of FIG. 2) in that there is an additional storage unit (that does not face a preparation station), referenced A5 and situated upstream to the storage unit A4 (first other storage unit facing a preparation station) along the direction SC1.

In this case, the system enables a conveying of loads between N storage units and M preparation stations, with N=5 and M=4. There are K couples each comprising a storage unit and a preparation station facing each other on either side of the first and second collectors, with K=min (N, M)=4. For each of the K couples, the system comprises a pair of junction conveyors (ja, jr).

The storage unit A5 is connected to the first collector C1 by a pair of conveyors comprising storage entry conveyor ia5 and a storage unit exit conveyor oa5. For the storage unit A5, the system comprises a single junction conveyor which is a return junction conveyor jr5 interconnecting the first and second collectors C1, C2 in the direction going from the second to the first collector. This return junction conveyor jr5 is aligned with the storage unit entry conveyor ia5. For the storage (return path), the return junction conveyor jr5 makes it possible for a load coming from one of the preparation stations P1 to P4 to go to the storage unit A5. For the removal of loads (on the outbound path) from the storage unit A5, the operation is identical to the one described further above with FIG. 2 in the case of a storage unit Ai situated upstream to the preparation station Pj along the direction SC1: the shortest path between the connection points oai/C1 and C2/ipj is formed by a portion of the first collector C1 followed by the outbound junction conveyor jaj (the one facing the preparation station Pj).

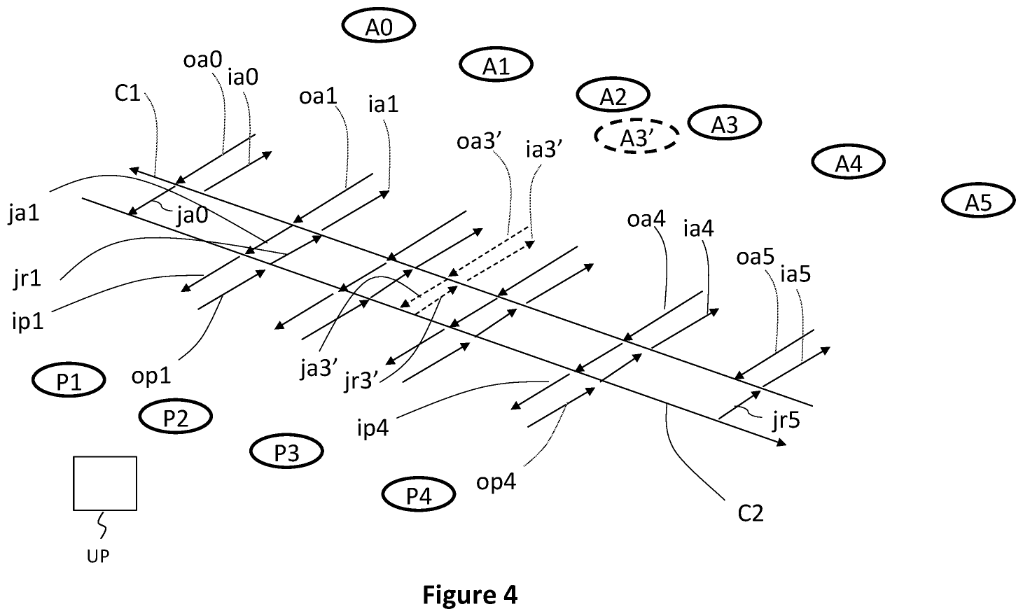

FIG. 4 illustrates a load-conveying system according to a third embodiment of the invention which is distinguished from the second embodiment (the one of FIG. 3) in that there are two additional storage units (that do not face a preparation station):
one of them is referenced A0 and is situated downstream to the storage unit A1 (the last other storage unit facing a preparation station) along the direction SC1; and
the other is referenced A3′ and situated between the storage units A2 and A3 (and more generally between A1 and A4) along the direction SC1.

In this case, the system makes it possible to convey loads between N storage units and M preparation stations, with N=7 and M=4. There are K couples each comprising a storage unit and a preparation station, facing each other on either side of the first and second collectors, with K=min (N, M)=4. For each of the K couples, the system comprises a pair of junction conveyors (ja, jr).

The storage unit A0 is connected to the first collector C1 by a pair of conveyors comprising a storage unit entry conveyor ia0 and a storage unit exit conveyor oa0. For the storage unit A0, the system comprises a single junction conveyor, which is an outbound junction conveyor ja0 interconnecting the first and second collectors C1, C2 in the direction going from the first to the second collector. This outbound junction conveyor ja0 is aligned with the storage unit exit conveyor oa0. For the removal of loads (outbound path) from the storage unit A0, the outbound junction conveyor ja0 makes it possible, for a load coming from the outbound storage unit A0, to go to one of the preparation stations P1 to P4. For the storage (return path) in the storage unit A0, the operation is identical to the one described further above with FIG. 2 in the case of a storage unit Ai′ situated downstream from the preparation station Pj′ along the direction SC1: the shortest path between the two connection points opi′/C2 and C1/iaj′ is formed by the return junction conveyor jrj′ (the one facing the preparation station Pj′) followed by a portion of the first collector C1.

The storage unit A3′ is connected to the first collector C1 by a pair of conveyors comprising a storage unit entry conveyor ia3′ and a storage unit exit conveyor oa3′. For the storage unit A3′, the system comprises a pair of junction conveyors (ja3′, jr3′) interconnecting the first and second collectors C1, C2 along opposite directions of movement and comprising an outbound junction conveyor ja3′, having a direction of movement from the first to the second collector and being aligned with the storage unit exit conveyor oa3′, and a return junction conveyor jr3′, having a direction of movement from the second to the first collector and being aligned with the storage unit entry conveyor ia3′. For the removal (outbound path) from the storage unit A3′, the cases 2 and 3 for the outbound path, described further above with FIG. 2, apply. For the storage (return path) into the storage unit A3′, the cases 2 and 3 for the return path described further above with FIG. 2 apply.

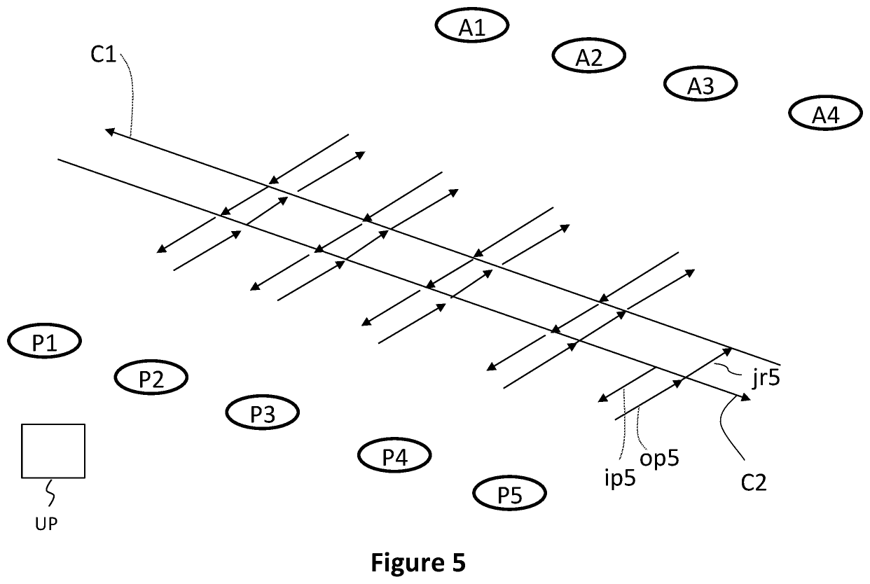

FIG. 5 illustrates a load-conveying system according to a fourth embodiment of the invention, which is distinguished from the first embodiment (the one of FIG. 2) in that there is an additional preparation station (that does not face a storage unit) referenced P5 and situated downstream from the preparation station P4 (the last other preparation station facing a storage unit) along the direction SC2.

In this case, the system enables a conveying of loads between N storage units and M preparation stations, with N=4 and M=5. There are K couples each comprising a storage unit and the preparation station facing each other on either side of the first and second collectors, with K=min (N, M)=4. For each of the K couples, the system comprises a pair of junction conveyors (ja, jr).

The preparation station A5 is connected to the second collector C2 by a pair of conveyors comprising a preparation station entry conveyor ip5 and a preparation station outbound conveyor op5. For the preparation station P5, the system comprises a single junction conveyor which is a return junction conveyor jr5 interconnecting the first and second collectors C1, C2 in the direction going from the second to the first collector. This return junction conveyor jr5 is aligned with the preparation station exit conveyor op5. For the storage (return path), the return junction conveyor jr5 enables a load coming from the preparation station P5 to go to one of the storage units A1 to A4. For the load removal (outbound path) from one of the storage units A1 to A4, the operation is identical to the one described further above with reference to FIG. 2 in the case of a storage unit Ai situated downstream to the preparation station Pj along the direction SC1: the shortest path between the connection points oai/C1 et C2/ipj is formed by the outbound junction conveyor jai (the one facing the storage unit Ai) followed by a portion of the second collector C2.

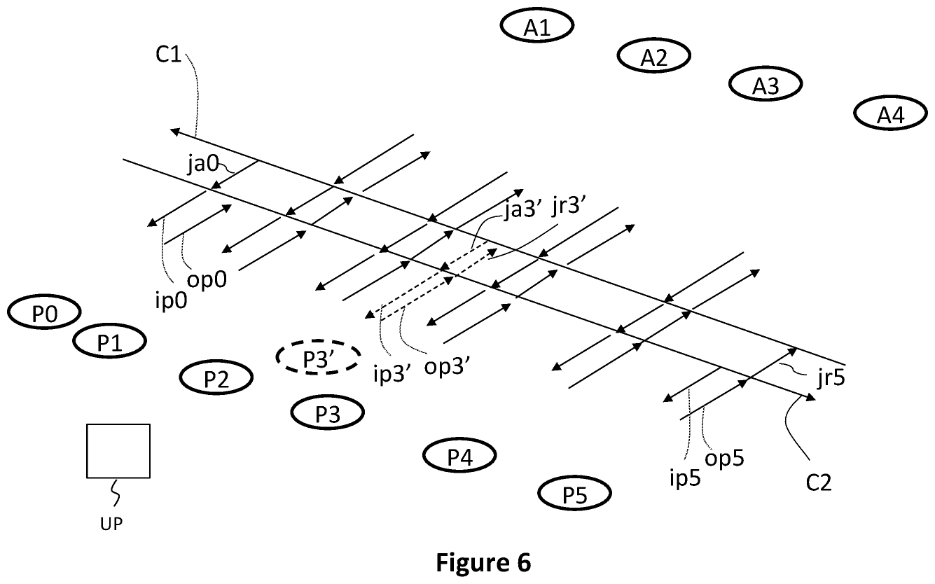

FIG. 6 illustrates a load-conveying system according to a fifth embodiment of the invention which is distinguished from the fourth embodiment (the one of FIG. 5) in that there are two additional preparation stations (that do not face a storage unit):
one of them is referenced P0 and is situated upstream to the preparation station P1 (the first other preparation station facing a storage unit) along the direction SC2; and
the other is referenced P3′ and is situated between the preparation stations P2 and P3 (and more generally between P1 and P4) along the directions SC2.

The system in this case enables a conveying of loads between N storage units and M preparation stations, with N=4 and M=7. There are K couples each comprising a storage unit and a preparation station facing each other on either side of the first and second collectors, with K=min (N, M)=4. For each of the K couples, the system comprises a pair of junction conveyors (ja, jr).

The preparation station P0 is connected to the second collector C2 by a pair of conveyors comprising a preparation station entry conveyor ip0 and a preparation station exit conveyor op0. For the preparation station P0, the system comprises a single junction conveyor which is an outbound junction conveyor ja0 interconnecting the first and second collectors C1, C2 in the direction going from the first collector to the second collector. This outbound junction conveyor ja0 is aligned with the preparation station entry conveyor ip0. For the removal of loads (outbound path), the outbound junction conveyor ja0 enables a load coming from one of the storage units A1 to A4 to go to the preparation station P0. For the storage (return path) from the preparation station P0 to one of the storage units A1 to A4, the operation is identical to the one described further above with FIG. 2, in the case of a storage unit Ai′ situated upstream to the preparation station Pj′ along the direction SC1: the shortest path between the connection points opi′/C2 and C1/iaj′ is formed by a portion of the second collector C2 followed by the return junction conveyor jri′ (the one facing the storage unit Ai′).

The preparation station P3′ is connected to the second collector C2 by a pair of conveyors comprising a preparation station entry conveyor ip3′ and a preparation station exit conveyor op3′. For the preparation station P3′, the system comprises a pair of junction conveyors (ja3′, jr3′) interconnecting the first and second collectors C1, C2 along opposite directions of movement and comprising an outbound junction conveyor ja3′, having a direction of movement from the first to the second collector and aligned with the preparation station entry conveyor ip3′, and a return junction conveyor jr3′, having a direction of movement from the first to the second collector and being aligned with the preparation station exit conveyor op3′. For the load removal (the outbound path) to the preparation station P3′, the cases 2 and 3 for the outbound path described further above with FIG. 2 are applicable. For the storage (return path) from the preparation station P3′, the cases 2 and 3 for the return path described further above with FIG. 2 are applicable.

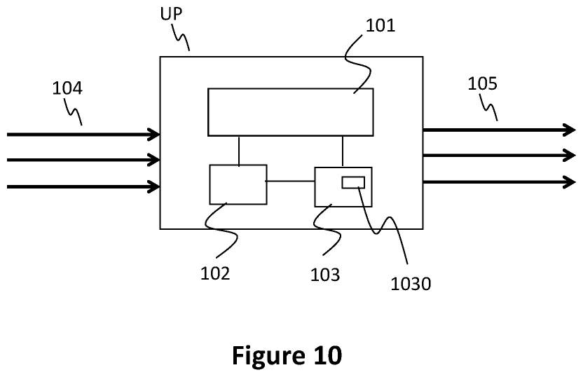

FIG. 10 presents an example of a structure of the above-mentioned management unit UP, according to one particular embodiment of the invention. The management unit UP comprises a random-access memory 102 (for example a RAM), a processing unit 101 equipped for example with a processor and managed by a computer program 1030 stored in a read-only memory 103 (for example a ROM or a hard disk drive). At initialization, the code instructions of the computer program are for example loaded into the random-access memory 102 and then executed by the processor of the processing unit 101. The processing unit 101 inputs signals 104, processes them and generates output signals 105.

The input signals 104 comprise various pieces of information on the operating of the general system (comprising especially the storage units, the preparation stations, the collectors, the storage unit entry conveyors, the storage unit exit conveyors, the preparation station entry conveyors, the preparation station exit conveyors, the outbound junction conveyors, the return junction conveyors), especially the load identifiers read (by barcode or RFID label types of reader devices, etc.) on the loads when they pass by different places in the general system (for example, at the extremities of the different conveyors).

The output signal 105 comprises various pieces of control information for the management of the devices of the general system in order to manage the movements of the loads in the general system.

This FIG. 10 illustrates only one particular implementation among several possible implementations. Indeed, the management unit UP can be made equally well on a reprogrammable computing machine (a PC computer, a DSP processor or a microcontroller) executing a program comprising a sequence of instructions and/or on a dedicated computing machine (for example a set of logic gates such as an FPGA or an ASIC or any other hardware module). Should the management unit be implanted at least partly on a reprogrammable computation machine, the corresponding program (i.e. the sequence of instructions) can be stored in a storage medium that is detachable(such as for example a floppy disk, a CD ROM or a DVD ROM) or not detachable, this storage medium being partially or totally readable by a computer or a processor.

It is clear that many other embodiments of the invention can be envisaged without departing from the framework of the present invention, especially as a function of the values taken by the number N of storage units and the number M of preparation stations (as described further above, through several examples, three cases are possible: N=M, N<M and N>M).

An exemplary embodiment of the present disclosure overcomes the different drawbacks of the prior art.

More specifically, an exemplary embodiment provides a system for conveying loads without sequencing, between a plurality of storage units and a plurality of preparation stations, the system not having the drawbacks related to the use of a loop (carousel).

An exemplary embodiment provides a system of this kind to minimize the distances travelled by the loads and to increase the quality of loads that can be conveyed simultaneously.

An exemplary embodiment provides a system of this kind that has a multiplier effect on the use of the devices that constitute it (in particular collectors and conveyors).

An exemplary embodiment provides a system of this kind that is simple to implement and costs little.

1. A system for conveying loads without sequencing, between a plurality of storage units and a plurality of preparation stations, wherein the system comprises:
first and second collecting conveyors, positioned on a same horizontal plane, parallel, mono-directional and having opposite directions of movement;
to connect each storage unit to the first collecting conveyor, a storage unit entry conveyor and a storage unit exit conveyor;
to connect each preparation station to the second collecting conveyor, a preparation station entry conveyor and a preparation station exit conveyor;
for at least one couple comprising a storage unit of the plurality of storage units and a preparation station of the plurality of preparation stations facing each other on either side of the first and second collecting conveyors, a pair of junction conveyors interconnecting the first and second collecting conveyors and comprising:
an outbound junction conveyor having a direction of movement from the first to the second collecting conveyor; and
a return junction conveyor having a direction of movement from the second to the first collecting conveyor.

2. The system according to claim 1, wherein the outbound junction conveyor is aligned with the storage unit exit conveyor and the preparation station entry conveyor, respectively associated with the storage unit and with the preparation station of said at least one couple, and wherein the return junction conveyor is aligned with the storage unit entry conveyor and the preparation station exit conveyor respectively associated with the storage unit and the preparation station for said at least one couple.

3. The system according to claim 1, wherein the storage unit entrance conveyors, the storage unit exit conveyors, the preparation station entrance conveyors, the preparation station exit conveyors, the outbound junction conveyors and the return junction conveyors are perpendicular to the first and second collecting conveyors.

4. The system according to claim 1, for a conveying of loads between N storage units and M preparation stations, K couples each comprising a storage unit of the plurality of storage units and a preparation station of the plurality of preparation stations facing each other on either side of the first and second collecting conveyors, with K=min (N, M), wherein the system comprises a pair of junction conveyors for each of the K couples.

5. The system according to claim 1, a given load having to be conveyed:
from a given one of the storage units, of which the associated storage unit exit conveyor is connected to the first collecting conveyor at a first connection point,
to a given one of the preparation stations, of which the associated preparation station entry conveyor is connected to the second collecting conveyor at a second connection point,
wherein the system comprises a management unit for managing collecting conveyors and junction conveyors of said system, said management unit being configured so that, between the first and second connection points, the given load is transported in travelling through a minimum distance:
via an outbound junction conveyor positioned between the given storage unit and the given preparation station, if the given storage unit and the given preparation station face each other;
via a portion of the first collecting conveyor and an outbound junction conveyor positioned facing the given preparation station, if the given storage unit is upstream to the given preparation station, in the direction of movement of the first collecting conveyor;
via an outbound junction conveyor positioned so as to be facing the given storage unit and a portion of the second collecting conveyor, if the given storage unit is downstream to the given preparation station, in the direction of movement of the first collecting conveyor.

6. The system according to claim 1, a given load having to be conveyed:
from a first given storage unit, of which the associated storage unit exit conveyor is connected to the first collecting conveyor at a first connection point,
to a second given storage unit, of which the associated storage unit entry conveyor is connected to the first collecting conveyor at a third connection point,
wherein the system comprises a management unit for managing the collecting conveyors and the junction conveyors of said system, said management unit being configured so that between the first and third connection points, the given load is transported in travelling through a minimum distance:
via a portion of the first collecting conveyor, if the first given storage unit is upstream to the second given storage unit, in the direction of movement of the first collecting conveyor;
via an outbound junction conveyor positioned facing the first given storage unit, a portion of the second collecting conveyor and a return junction conveyor positioned facing the second given storage unit, if the first given storage unit is downstream to the second given storage unit, in the direction of movement of the first collecting conveyor.

7. The system according to claim 1, a given load having to be conveyed:
from a given one of the preparation stations, of which the associated preparation station exit conveyor is connected to the second collecting conveyor at a fourth connection point,
to a given one of the storage units, of which the associated storage unit entry conveyor is connected to the first collecting conveyor at a fifth connection point,
the system comprises a management unit for managing the collecting conveyors and the junction conveyors of said system, said management unit being configured so that, between the fourth and fifth connection points, the given load is transported in travelling a minimum distance:
via a return junction conveyor positioned between the given preparation station and the given storage unit, if the given storage unit and the given preparation station face each other;
via a portion of the second collecting conveyor and a return junction conveyor positioned facing the given storage unit if the given storage station is upstream to the given preparation station, in the direction of movement of the first collecting conveyor;
via a return junction conveyor positioned facing the given preparation station and a portion of the first collecting conveyor, if the given storage unit is downstream to the given preparation station, in the direction of movement of the first collecting conveyor.

8. The system according to claim 1, a given load having to be conveyed:
from a first given preparation station, of which the associated preparation station exit conveyor is connected to the second collecting conveyor at a fourth connection point,
to a second given preparation station, of which the associated given preparation station entry conveyor is connected to the second collecting conveyor at a sixth connection point,
wherein the system comprises a management unit for managing the collecting conveyors and junction conveyors of said system, said managing unit being configured so that, between the fourth and sixth connection points, the given load is transported in travelling a minimum distance:
via a portion of the second collecting conveyor, if the first given preparation station is downstream to the given second preparation station, in the direction of movement of the first collecting conveyor;
via a return junction conveyor positioned facing the first given preparation station, a portion of the first collecting conveyor and an outbound junction conveyor positioned facing the second given preparation station, if the first given preparation station is upstream to the second given preparation station, in the direction of movement of the first collecting conveyor.

9. The system according to claim 1, wherein, for at least one storage unit of the plurality of storage units that does not face a preparation station of the plurality of preparation stations and is situated, in the direction of movement of the first collecting conveyor, upstream to the first other storage unit facing a preparation station, the system comprises a single junction conveyor which is a return junction conveyor interconnecting the first and second collecting conveyors in the direction going from the first to the second collecting conveyor, and is aligned with the entry conveyor of the storage unit associated with said at least one storage unit.

10. The system according to claim 1, wherein, for at least one storage unit of the plurality of storage units that is not facing a preparation station of the plurality of preparation stations and is situated along the direction of movement of the first collecting conveyor, downstream to the last other storage unit facing a preparation station, the system comprises a single junction conveyor which is an outbound junction conveyor interconnecting the first and second collecting conveyors in the direction going from the first collecting conveyor to the second collecting conveyor and which is aligned with the storage unit exit conveyor associated with said at least one storage unit.

11. The system according to claim 1, wherein, for at least one storage unit of the plurality of storage units that is not facing a preparation station of the plurality of preparation stations and is situated, along the direction of movement of the first collecting conveyor, between two other storage units each facing a preparation station of the plurality of preparation stations, the system comprises a pair of junction conveyors interconnecting the first and second collecting conveyors in opposite directions of movement and comprising an outbound junction conveyor having a direction of movement from the first to the second collecting conveyor and aligned with the storage unit exit conveyor associated with said at least one storage unit, and a return junction conveyor, having a direction of movement from the second to the first collecting conveyor and aligned with the entry conveyor of the storage unit associated with said at least one storage unit.

12. The system according to claim 1, wherein, for at least one preparation station of the plurality of preparation stations that does not face a storage unit of the plurality of storage units and is situated, in the direction of movement of the second collecting conveyor, upstream to the first other preparation station facing a storage unit of the plurality of storage units, the system comprises a single junction conveyor which is an outbound junction conveyor interconnecting the first and second collecting conveyors in the direction going from the first to the second collecting conveyor, and which is aligned with the preparation station entry conveyor associated with said at least one preparation station.

13. The system according to claim 1, wherein, for at least one preparation station of the plurality of preparation stations that does not face a storage unit of the plurality of storage units and is situated, in the direction of movement of the second collecting conveyor, downstream to the last other preparation station of the plurality of preparation stations facing a storage unit of the plurality of storage units, the system comprises a single junction conveyor that is a return junction conveyor, interconnecting the first and second collecting conveyors in the direction going from the second to the first collecting conveyor, and which is aligned with the associated preparation station exit conveyor associated with said at least one preparation station.

14. The system according to claim 1, wherein, for at least one preparation station of the plurality of preparation stations that does not face a storage unit of the plurality of storage units and is situated, in the direction of movement of the second collecting conveyor, between two other preparation stations of the plurality of preparation stations each facing a storage unit of the plurality of storage units, the system comprises a pair of junction conveyors interconnecting the first and second collecting conveyors in opposite directions of movement and comprising an outbound junction conveyor having a direction of movement from the first to the second collecting conveyor and being aligned with the preparation station entry conveyor associated with said at least one preparation station, and a return junction conveyor, having a direction of movement from the second to the first collecting conveyor and being aligned with the preparation station exit conveyor associated with said at least one preparation station.
